(19) United States
(12) Patent Application Publication
(10) Pub. No.: US 2016/0343060 A1
(43) Pub. Date: Nov. 24, 2016

(54) INFORMATION PROVIDING SYSTEM AND MOBILE ELECTRONIC DEVICE

(71) Applicant: KYOCERA CORPORATION, Kyoto-shi (JP)

(72) Inventor: Hiroki ITO, Yokohama-shi (JP)

(21) Appl. No.: 15/227,967

(22) Filed: Aug. 4, 2016

Related U.S. Application Data
(63) Continuation of application No. 13/869,257, filed on Apr. 24, 2013.

(30) Foreign Application Priority Data
Apr. 24, 2012 (JP) 2012-099220

(51) Int. Cl. G06Q 30/06; G06F 9/445; H04M 1/725

(52) U.S. Cl. CPC G06Q 30/0631; H04M 1/72522; G06F 8/61

(57) ABSTRACT

According to an aspect, a mobile electronic device includes: a display unit; a storage unit for storing therein log information indicating a usage pattern of a first application; and a control unit for displaying information related to a second application on the display unit at a timing determined based on usage characteristic of the first application. The usage characteristic is analyzed based on the log information and includes a characteristic related to a timing of usage.

### CROSS-REFERENCE TO RELATED APPLICATIONS

This application is a Continuation of U.S. patent application Ser. No. 13/869,257 filed on Apr. 24, 2013, which claims priority from Japanese Application No. 2012-099220, filed on Apr. 24, 2012, the content of which is incorporated by reference herein in its entirety.

### BACKGROUND

1. Technical Field

The present application relates to an information providing system and a mobile electronic device capable of providing information on an application program matched to the characteristics of a user to the user.

2. Description of the Related Art

Recently, many of mobile electronic devices such as a smartphone are configured so as to enable a function to be extended by downloading and installing an application program (hereinafter, also called simply “application” or “app”) thereinto. The application is stored in a server accessible by a mobile electronic device over a network, which can be referred to, for example, JP-A-2010-182309.

It is preferred that various applications be prepared in order to meet various needs. However, if the number of applications to be stored in a server is increased, then it becomes difficult for the user to decide which of the applications should be installed into the mobile electronic device. For the foregoing reasons, there is a need for an information providing system and a mobile electronic device capable of providing information on an application matched to characteristics of a user of a mobile electronic device to the user.

### SUMMARY

According to an aspect, an information providing system includes a mobile electronic device and an information providing apparatus. The information providing apparatus includes a log acquiring unit, a characterization unit, and a characterization unit. The log acquiring unit acquires log information indicating a usage pattern of a first application in the mobile electronic device from the mobile electronic device. The characterization unit analyzes a usage characteristic of the first application in the mobile electronic device based on the log information acquired from the mobile electronic device, the usage characteristic including a characteristic related to a timing of usage. The recommendation-information creating unit is configured to determine a second application whose usage in the mobile electronic device is recommended based on an analysis result of the characterization unit and an evaluation value calculated using a result of analyzing usage patterns of a plurality of applications in a plurality of mobile electronic devices, determine a timing of presenting information related to the second application in the mobile electronic device based on the analysis result of the characterization unit, and create recommendation information including information related to the second application and information related to the timing. The mobile electronic device includes: a display unit; a storage unit for storing therein the log information; and a control unit for displaying the information related to the second application included in the recommendation information on the display unit at the timing included in the recommendation information.

According to another aspect, an information providing system includes a mobile electronic device and an information providing apparatus. The information providing apparatus includes a log acquiring unit, a characterization unit, and a characterization unit. The log acquiring unit acquires log information indicating a usage pattern of a first application in the mobile electronic device from the mobile electronic device. The characterization unit analyzes a usage characteristic of the first application in the mobile electronic device based on the log information acquired from the mobile electronic device, the usage characteristic including a characteristic related to a timing of usage. The recommendation-information creating unit is configured to determine a second application whose usage in the mobile electronic device is recommended based on an analysis result of the characterization unit and a result of analyzing usage patterns of a plurality of applications in a plurality of mobile electronic devices, determine a timing of presenting information related to the second application in the mobile electronic device based on the analysis result of the characterization unit, and create recommendation information including information related to the second application and information related to the timing. The mobile electronic device includes a display unit; a storage unit for storing therein the log information; and a control unit for displaying the information related to the second application included in the recommendation information on the display unit at the timing included in the recommendation information.

According to another aspect, a mobile electronic device includes: a display unit; a storage unit for storing therein log information indicating a usage pattern of a first application; and a control unit for displaying information related to a second application on the display unit at a timing determined based on usage characteristic of the first application. The usage characteristic is analyzed based on the log information and includes a characteristic related to a timing of usage.

### BRIEF DESCRIPTION OF THE DRAWINGS

FIG. 1 is a diagram illustrating a configuration of an information providing system according to an embodiment;

FIG. 2 is a diagram illustrating an overview of operations of the information providing system;

FIG. 3 is a block diagram of an information providing apparatus;

FIG. 4 is a diagram illustrating an example of log information;

FIG. 5 is a diagram illustrating an example of app information;

FIG. 6 is a diagram illustrating an example of rule information;

FIG. 7 is a diagram illustrating an example of analysis information;

FIG. 8 is a diagram illustrating an example of characteristic information;

FIG. 9 is a diagram illustrating an example of recommendation information;

FIG. 10 is a block diagram of a mobile phone;

FIG. 11 is a diagram illustrating an example of the log information;

FIG. 12 is a diagram illustrating an example of the recommendation information;

FIG. 13 is a flowchart illustrating an operation of the information providing apparatus;

FIG. 14 is a flowchart illustrating an operation of the mobile phone;

FIG. 15 is a diagram illustrating an example of a screen used to recommend one of applications; and

FIG. 16 is a diagram illustrating an example of a screen used to recommend a plurality of applications.

### DETAILED DESCRIPTION

Exemplary embodiments of the present invention will be explained in detail below with reference to the accompanying drawings. A mobile phone will be explained below as an example of a mobile electronic device.

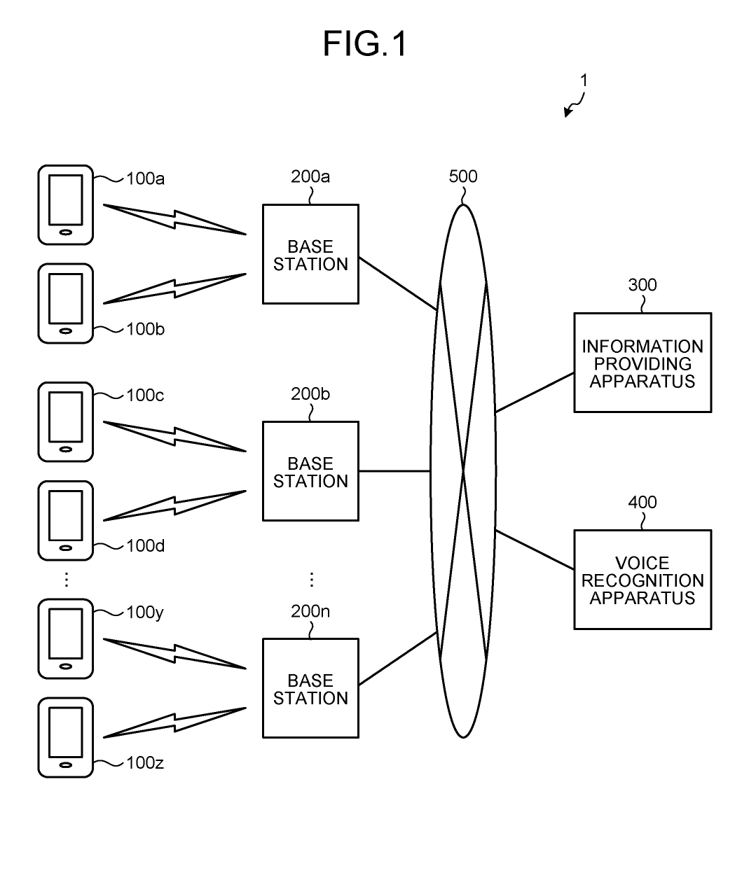

A configuration of an information providing system 1 according to an embodiment will be explained below with reference to FIG. 1. As illustrated in FIG. 1, the information providing system 1 includes mobile phones 100a to 100z, base stations 200a to 200n, an information providing apparatus 300, and a voice recognition apparatus 400. In the description below, the mobile phones 100a to 100z may be collectively referred to as a mobile phone 100 without specifying which is which and the base stations 200a to 200n may be collectively referred to as a base station 200 without specifying which is which.

The mobile phone 100 can install an arbitrary application in order to extend the function. The app to be installed into the mobile phone 100 is downloaded from a server that is managed by, for example, a manufacturer of the mobile phone 100, a telecommunications provider, other organization, etc. The mobile phone 100 accumulates log information related to a usage pattern of an app and transmits the accumulated log information to the information providing apparatus 300.

The base station 200, the information providing apparatus 300, and the voice recognition apparatus 400 are communicably connected to each other through a network 500.

The base station 200 establishes a wireless communication path with a mobile phone 100 located within a communication area to enable the mobile phone 100 to communicate with other device through the wireless communication path. In the following explanation on the communication of the mobile phone 100, for the sake of simplicity, the description of the base station 200 may be omitted.

The information providing apparatus 300 provides information on an app whose installation is recommended to mobile phones 100 based on the log information transmitted from the mobile phones 100. The information to be provided to each of the mobile phones 100 by the information providing apparatus 300 differs according to the usage pattern of the app in the mobile phone 100.

The voice recognition apparatus 400 analyzes the contents of voice information transmitted from other device through a voice recognition process, and transmits the analyzed contents to the source device. For example, when the mobile phone 100 transmits voice information on user's voice recorded thereby to the voice recognition apparatus 400, the voice recognition apparatus 400 analyzes the contents of the voice information through the voice recognition process, and transmits the analyzed contents as text data to the mobile phone 100. A voice operation of the mobile phone 100 is implemented by the configuration.

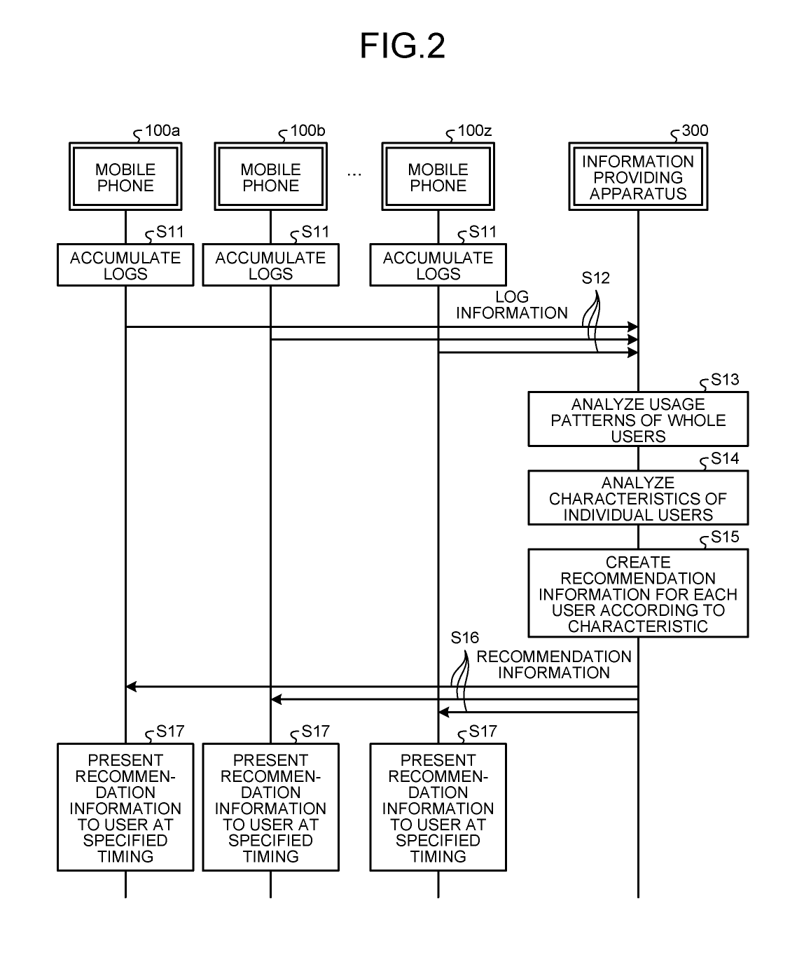

An overview of operations of the information providing system 1 will be explained below with reference to FIG. 2. As illustrated in FIG. 2, each of the mobile phones 100 accumulates log information related to the usage pattern of an app (Step S11). Recorded in the log information are, for example, installation, uninstallation, execution, termination, and operation of an app, in a manner associated with time and location on which each of them is performed. The mobile phone 100 may be configured so that the user can specify an app whose log information is not accumulated. The mobile phone 100 may be configured so that the user can specify at least either one of a time period during which log information is not accumulated and an area where log information is not accumulated.

The accumulated log information is transmitted to the information providing apparatus 300 (Step S12). A timing of transmitting the log information may be determined by the mobile phone 100 or by the information providing apparatus 300. The log information during transmission is concealed so that its content cannot be read by a third party even if it is referred to. Concealment is implemented by combining technologies such as encoding to replace the content with predetermined codes, encryption to prevent reproduction of the content without a key, and fragmentation to prevent the whole content from being read. To cut the amount of communication, the encoding may be performed so that the size of the log information is reduced.

The information providing apparatus 300 analyzes the usage patterns of apps of whole users based on the transmitted log information (Step S13). For example, the information providing apparatus 300 analyzes which of the apps is most used and which of the apps is increasingly installed. Also, the information providing apparatus 300 extracts an app that is featured by its usage pattern, such as an app frequently used in a specific time period and an app frequently used in a specific region.

The information providing apparatus 300 also analyzes usage characteristics of apps in the mobile phones 100, i.e., analyzes the characteristics of individual users, based on the transmitted log information (Step S14). For example, the information providing apparatus 300 extracts a frequently used app for each user. Also, the information providing apparatus 300 extracts an app that is featured by the usage pattern for each user, such as an app frequently used in a specific time period and an app frequently used in a specific region.

The information providing apparatus 300 then creates recommendation information for each user according to the characteristic of each of the users of the mobile phones 100 based on these results (Step S15). The recommendation information includes information on an app whose installation is recommended and also information on a timing of presenting the information on the app to the user. The timing of presenting the information on the app to the user is determined based on the time or the region or the like according to the characteristic of an app and the characteristic of a user.

The recommendation information is transmitted from the information providing apparatus 300 to the mobile phone 100 of a corresponding user (Step S16). The recommendation information during transmission may be concealed similarly to the log information during transmission.

Each of the mobile phones 100 presents information on a specified app to the user at a specified timing based on the transmitted recommendation information (Step S17). If the user becomes interested in the presented information, then he/she will install the recommended app and try it.

With the configuration as above, an app suitable for the user selected from among a number of apps can be presented to the user. Accordingly, user convenience is improved and the level of user satisfaction with the mobile phone 100 is enhanced.

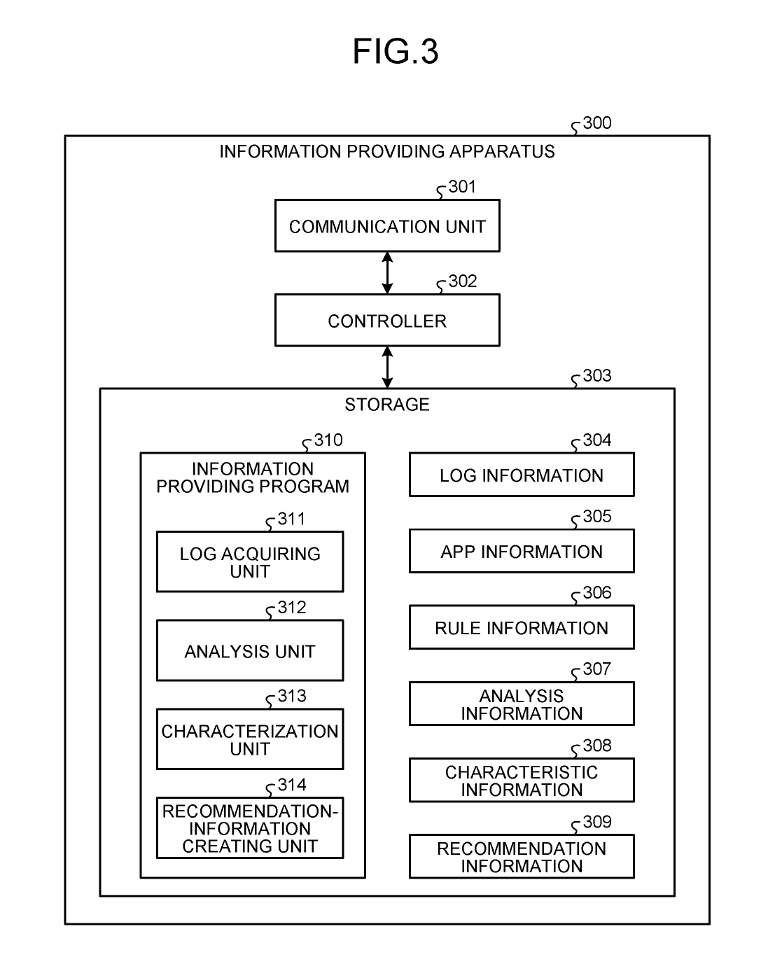

The configuration of the information providing apparatus 300 will be explained below with reference to FIG. 3 to FIG. 9. As illustrated in FIG. 3, the information providing apparatus 300 includes a communication unit 301, a controller 302, and a storage 303. The communication unit 301 enables communication with other devices based on a predetermined protocol.

The controller 302 is a processing unit such as Central Processing Unit (CPU). The controller 302 integrally controls the operations of the information providing apparatus 300 to implement various functions. Specifically, the controller 302 executes instructions contained in the program stored in the storage 303 while referring to the data stored in the storage 303 as necessary. The controller 302 executes various information processes according to the data and the instructions.

The controller 302 executes, for example, an information providing program 310 to implement a function for providing recommendation information related to an app to the mobile phone 100.

The storage 303 stores therein programs and data. The storage 303 is used also as a work area that temporarily stores a processing result of the controller 302. The storage 303 may include any non-transitory storage medium such as a semiconductor storage medium and a magnetic storage medium. The storage 303 may include a plurality type of storage mediums. The storage 303 may include a combination of a portable storage medium such as a memory card, an optical disc, or a magneto-optical disc with a reader of the storage medium. The storage 303 may include a storage device used as a temporary storage area such as Random Access Memory (RAM).

The storage 303 stores therein, for example, log information 304, app information 305, rule information 306, analysis information 307, characteristic information 308, recommendation information 309, and the information providing program 310.

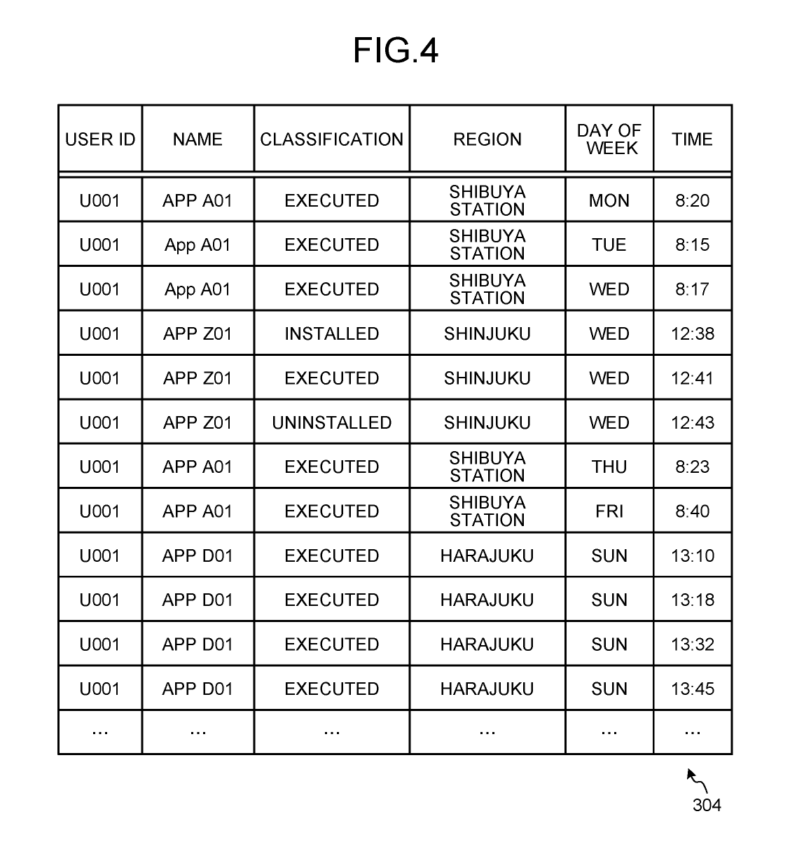

Stored in the log information 304 is log information transmitted from the mobile phones 100. Each of the data stored in the log information 304 corresponds to an event related to an app. An example of the log information 304 is illustrated in FIG. 4. As illustrated in FIG. 4, the log information 304 includes items such as User ID, Name, Classification, Region, Day of Week, and Time.

Stored in the item of User ID is an identifier that identifies a user of a mobile phone 100. Stored in the item of Name is a name of an app. The log information 304 may include an item for storing therein an identifier that identifies an app.

Stored in the item of Classification is a value indicating a type of an event, such as “Installed” indicating that an app has been installed, “Uninstalled” indicating that an app has been uninstalled, and “Executed” indicating that an app has been executed. The item of Classification may include any other value such as a value indicating that an app has been terminated, a value indicating that the setting of an app has been changed, and a value indicating that an app has been operated. The log information 304 may further include an item for storing therein a value indicating setting or details of an operation.

Stored in the item of Region is a value indicating a region where an event has occurred. The value indicating the region may be a name such as a place name or a code, or may be numerical values such as a latitude and a longitude. Stored in the item of Day of Week is a day of the week on which an event has occurred. The log information 304 may include an item for storing therein a date on which an event has occurred. Stored in the item of Time is the time at which an event has occurred.

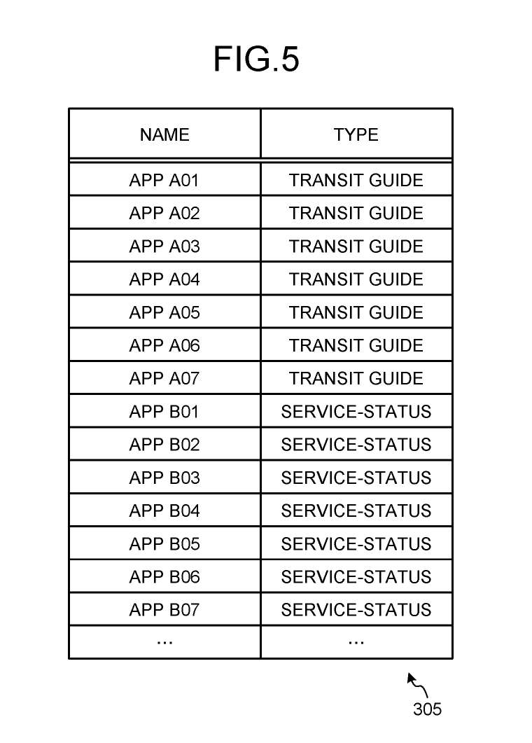

Stored in the app information 305 is information related to available apps and their types. An example of the app information 305 is illustrated in FIG. 5. As illustrated in FIG. 5, the app information 305 includes items such as Name and Type. Stored in the item of Name is a name of an app. The app information 305 may include an item for storing therein an identifier that identifies an app. Stored in the item of Type is a value indicating a type of an app.

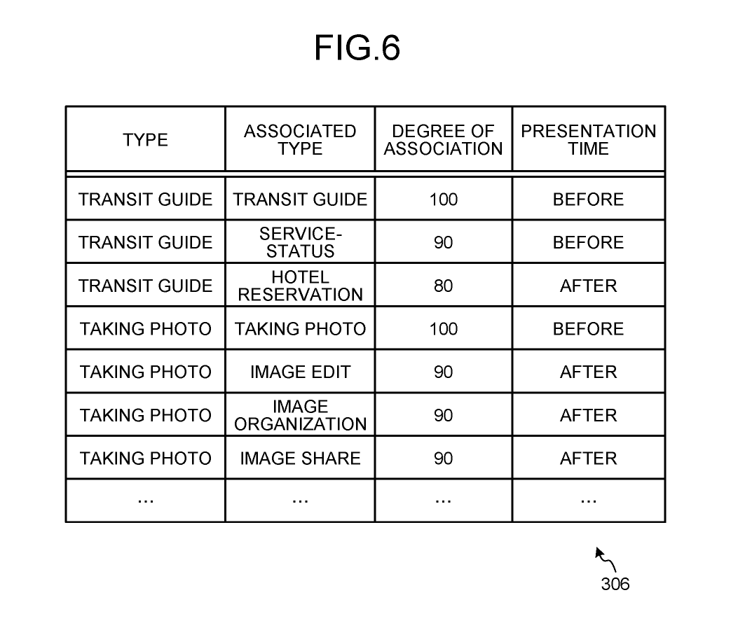

Stored in the rule information 306 is information related to rules to create information on an app to be recommended. An example of the rule information 306 is illustrated in FIG. 6. As illustrated in FIG. 6, the rule information 306 includes items such as Type, Associated Type, Degree of Association, and Presentation Time.

Stored in the item of Type is a value indicating a type of an app. Stored in the item of Associated Type is a value indicating a type associated with a type indicated by the value in the item of Type. A same value as the value in the item of Type may be stored in the item of Associated Type. Stored in the item of Degree of Association is a value indicating a degree of association between the type indicated by the value in the item of Type and the type indicated by the value in the item of Associated Type. For example, the higher the similarity between functions of corresponding apps is, the higher the degree of association between the types becomes. Also, the higher the frequency of using the functions of corresponding apps in combination with each other, the higher the degree of association between the types becomes. In the present embodiment, the item of Degree of Association stores any number among 0 to 100, which indicates that if the number is larger, the degree of association is higher.

Stored in the item of Presentation Time is a value indicating whether a timing of presenting information on an app to be recommended should be before or after the characteristic timing of a user. The details of the timing of presenting the information on the app to be recommended will be explained later.

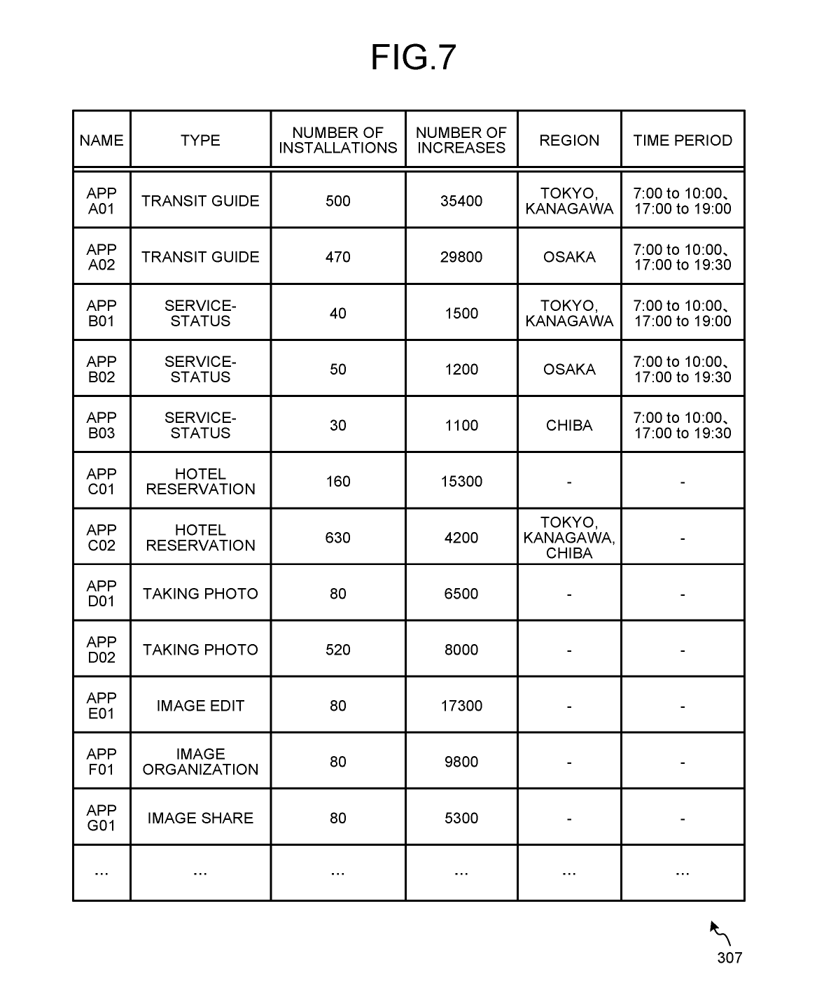

Stored in the analysis information 307 is information related to usage patterns of apps of the whole users obtained by analyzing the log information 304. An example of the analysis information 307 is illustrated in FIG. 7. As illustrated in FIG. 7, the analysis information 307 includes items such as Name, Type, Number of Installations, Number of Increases, Region, and Time Period. Stored in the item of Name is a name of an app. Stored in the item of Type is a value indicating a type of an app.

Stored in the item of Number of Installations is the number of installations of an app. Number of Installations may be the number of mobile phones 100 in which the app is currently installed or may be the number of mobile phones 100 in which the app has been installed even once. Stored in the item of Number of Increases is the number of increases of an app in a latest predetermined period. The number of increases may be the number of mobile phones 100 in which the app is installed in a last predetermined period or may be the number obtained by subtracting the number of mobile phones 100 from which the app is uninstalled in the last predetermined period from the number of mobile phones 100 in which the app is installed in the last predetermined period.

Stored in the item of Region is zero or more values indicating the region where an app is characteristically often used. The region where an app is characteristically often used is the one where the number of uses of the app per user in the predetermined period is larger than a threshold. The threshold used to determine whether the region is the one where an app is characteristically often used may be a previously statically determined value, or may be a dynamically determined value based on a value such as a deviation value or an average value of the number of uses of the app per user calculated in each region. The region determined how often the app is used is set by region units such as Kanto region or Kinki region, by district units such as Tokyo or Kanagawa prefecture, or by ward or municipal units such as Chiyoda Ward or Yokohama City. The region determined how often the app is used may be set by a smaller unit or may be set by a combination of a plurality of units representing different areas.

Stored in the item of Time Period is zero or more values indicating a time period during which an app is characteristically often used. The time period during which an app is characteristically often used is the one during which the number of uses of the app per user in the predetermined period is larger than a threshold. The threshold used to determine whether the time period is the one during which the app is characteristically often used may be a previously statically determined value, or may be a dynamically determined value based on a value such as a deviation value or an average value of the number of uses of the app per user calculated in each time period. The time period determined how often the app is used is set by, for example, the several hours, the hour, or the several tens of minutes. The time period determined how often the app is used may be set by a smaller unit or may be set by a combination of a plurality of units representing different lengths.

Each value of the items such as Number of Installations, Number of Increases, Region, and Time Period is set based on the data stored in the log information 304. Stored in the analysis information 307 is data for each app registered in the app information 305.

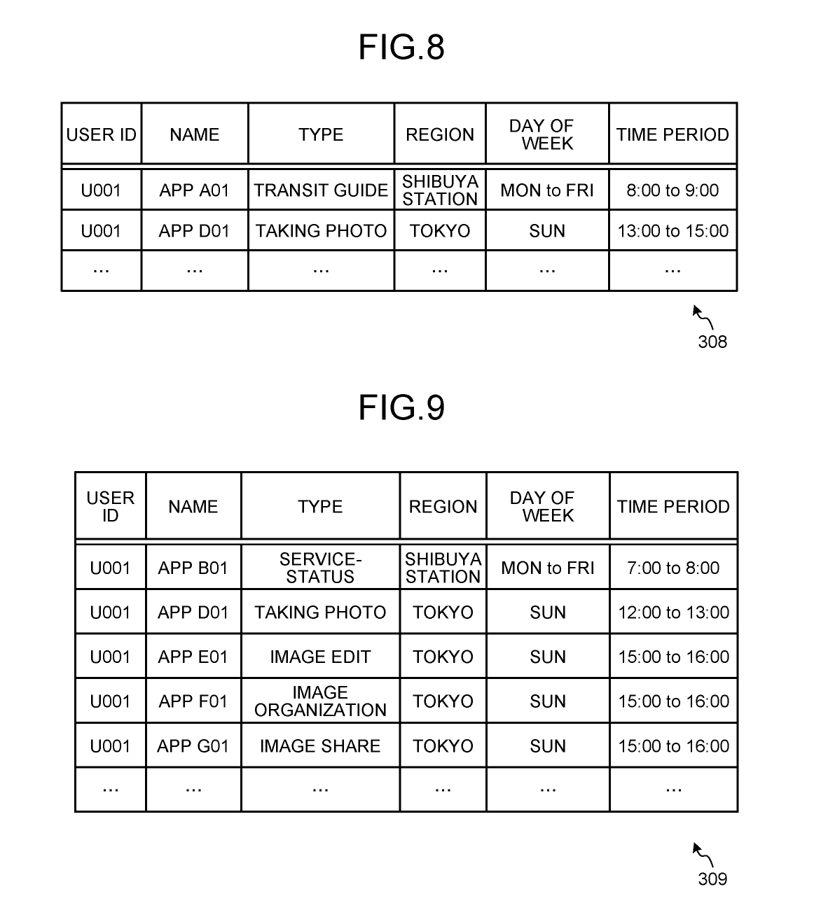

Stored in the characteristic information 308 is information related to the characteristics of a user using an app. An example of the characteristic information 308 is illustrated in FIG. 8. As illustrated in FIG. 8, the characteristic information 308 includes items such as User ID, Name, Type, Region, Day of Week, and Time Period. Stored in the item of User ID is an identifier that identifies a user of a mobile phone 100. Stored in the item of Name is a name of an app used by a user. Stored in the item of Type is a value indicating a type of an app used by a user.

Stored in the item of Region is zero or more values indicating a region where an app is characteristically often used by a user. The region where an app is characteristically often used by a user is the one where a counted value obtained by counting the number of uses of the app per user in the predetermined period in each region is larger than a threshold. The threshold used to determine whether the region is the one where the app is characteristically often used by a user may be a previously statically determined value, or may be a dynamically determined value based on a value such as a deviation value or an average value of counted values obtained by counting the number of uses of the app per user in each region.

Stored in the item of Day of Week is zero or more values indicating a day of the week on which an app is characteristically often used by a user. The day of the week on which an app is characteristically often used by a user is the one on which a counted value obtained by counting the number of uses of the app per user in the predetermined period on each day of the week is larger than a threshold. The threshold used to determine whether the day of the week is the one on which an app is characteristically often used by a user may be a previously statically determined value, or may be a dynamically determined value based on a value such as a deviation value or an average value of counted values obtained by counting the number of uses of the app per user on each day of the week.

Stored in the item of Time Period is zero or more values indicating a time period during which an app is characteristically often used by a user. The time period during which an app is characteristically often used by a user is the one during which a counted value obtained by counting the number of uses of the app per user in the predetermined period in each time period is larger than a threshold. The threshold used to determine whether the time period is the one during which an app is characteristically often used by a user may be a previously statically determined value, or may be a dynamically determined value based on a value such as a deviation value or an average value of counted values obtained by counting the number of uses of the app per user in each time period. The time period determined how often an app is used by a user is set by, for example, the several hours, the hour, or the several tens of minutes. The time period determined how often an app is used by a user may be set by a smaller unit or may be set by a combination of a plurality of units representing different lengths.

Values of the items of Region, Day of Week, and Time Period are set based on the data stored in the log information 304.

Stored in the recommendation information 309 is information related to an app whose installation is recommended to a user and also related to presentation conditions for presenting the information on the app to the user. The presentation conditions include a condition for a region, a condition for a day of the week, and a condition for a time period. An example of the recommendation information 309 is illustrated in FIG. 9. As illustrated in FIG. 9, the recommendation information 309 includes items such as User ID, Name, Type, Region, Day of Week, and Time Period. Stored in the item of User ID is an identifier that identifies a user of a mobile phone 100. Stored in the item of Name is a name of an app whose installation is recommended to a user. Stored in the item of Type is a value indicating a type of an app whose installation is recommended to a user.

The app whose installation is recommended to the user is calculated based on an evaluation value calculated using the rule information 306, the analysis information 307, and the characteristic information 308. The evaluation value is calculated for each user characteristic and for each app. In the present embodiment, an evaluation value E (a, c) of determining whether the app a is to be recommended to a user having a characteristic c is calculated based on the following equation.

$$E ( a , c ) = Eins ( a ) * Wins + Einc ( a ) * Winc + Er ( a , c ) * Wr + El ( a , c ) * Wl + Et ( a , c ) * Wt$$

Where Eins(a) is an evaluation value based on the number of installations of the app a. The evaluation value based on the number of installations becomes higher with an increase in the number of installations. Wins is a weight for adjusting the importance of the evaluation value based on the number of installations. Einc(a) is an evaluation value based on the number of increases of the app a. The evaluation value based on the number of increases becomes higher with an increase in the number of increases. Winc is a weight for adjusting the importance of the evaluation value based on the number of increases. In this way, by reflecting the number of installations and the number of increases in the evaluation value, popular apps can be introduced to the user. The number of installations and the number of increases of the app a can be acquired from the analysis information 307.

Er(a, c) is an evaluation value based on the degree of association between the app a and an app corresponding to the characteristic c. Er(a, c) is obtained by searching the rule information 306 using, as search keys, the type of an app a and the type set in the data of the characteristic information 308 corresponding to the characteristic c and by referring to the item of Degree of Association of the matched data. In this way, by reflecting the degree of association between the apps in the evaluation value, an app that the user is more likely to be interested in can be introduced to the user. Wr is a weight for adjusting the importance of the evaluation value based on the degree of association.

El(a, c) is an evaluation value based on the degree of conformity (degree of matching) between the region where the app a is often used and the region corresponding to the characteristic c. El(a, c) is highly evaluated when the region set in the data of the characteristic information 308 corresponding to the characteristic c is included in the region set in the data of the analysis information 307 corresponding to the app a. In this way, by reflecting the regional degree of conformity in the evaluation value, the app often used in a scene the same as the scene where the user uses the app can be introduced to the user. Wl is a weight for adjusting the importance of the evaluation value based on the degree of the conformity between the regions.

Et(a, c) is an evaluation value based on the degree of conformity between the time period during which the app a is often used and the time period corresponding to the characteristic c. Et(a, c) is highly evaluated when the time period set in the data of the characteristic information 308 corresponding to the characteristic c is included in the time period set in the data of the analysis information 307 corresponding to the app a. In this way, by reflecting the temporal degree of conformity in the evaluation value, the app often used in a time period the same as the time period during which the user uses the app can be introduced to the user. Wt is a weight for adjusting the importance of the evaluation value based on the degree of the conformity between the time periods.

Stored in the recommendation information 309 is data related to an app a and a user having the characteristic c in which the evaluation value E(a, c) higher than a threshold is calculated. The evaluation value E(a, c) may be calculated in each combination of all the apps corresponding to the data included in the analysis information 307 with all the characteristics corresponding to the data included in the characteristic information 308. Alternatively, to reduce the amount of calculations by narrowing apps whose evaluation values E(a, c) are calculated, the threshold may be set in at least one of the number of installations and the number of increases. In other words, the evaluation value E(a, c) of an unpopular app does not have to be calculated.

Set in the item of Region in the recommendation information 309 is a value indicating a region whose recommendation to the user should be executed. The region whose recommendation to the user should be executed is the one set in the data of the characteristic information 308 corresponding to the characteristic c. In other words, in the present embodiment, if the user often uses an app, related to the app whose installation is recommended, in a specific region, then the recommendation is executed at a timing when the user comes to the specific region.

Set in the item of Day of Week is a day of the week on which the recommendation to the user should be executed. The day of the week on which the recommendation to the user should be executed is the one set in the data of the characteristic information 308 corresponding to the characteristic c. In other words, in the present embodiment, if the user often uses an app, related to the app whose installation is recommended, on a specific day of the week, then the recommendation is executed on the specific day of the week.

Set in the item of Time Period is a time period during which the recommendation to the user should be executed. The time period during which the recommendation to the user should be executed is the one with a predetermined length before or after the time period set in the data of the characteristic information 308 corresponding to the characteristic c. Whether the time period during which the recommendation to the user should be executed is set before or after the time period corresponding to the characteristic c is determined based on the value in the item of Presentation Time in the rule information 306. If the value in the item of Presentation Time of data in the rule information 306 acquired when Er(a, c) is calculated is “before”, then the time period during which the recommendation to the user should be executed is set to “before” the time period corresponding to the characteristic c. If the value in the item of Presentation Time for data of the rule information 306 acquired when Er(a, c) is calculated is “after”, then the time period during which the recommendation to the user should be executed is set to “after” the time period corresponding to the characteristic c.

The value in the item of Presentation Time of the rule information 306 is previously set based on determination as to whether execution of recommendation before the app corresponding to the characteristic c is executed is effective or execution of recommendation after the app corresponding to the characteristic c is executed is effective. For example, when the app to be recommended performs the process using data created by the app corresponding to the characteristic c, the value in the item of Presentation Time of the rule information 306 is set to “after”. For example, if the app to be recommended is executed beforehand to enable the app corresponding to the characteristic c to be used more easily, then the value in the item of Presentation Time of the rule information 306 is set to “before”.

In this way, the timing is controlled regionally and temporally, which enables installation of an app to be effectively recommended at a more appropriate timing.

Each data of the recommendation information 309 is transmitted to a mobile phone 100 of a corresponding user. The timing when the data of the recommendation information 309 is to be transmitted to the mobile phone 100 may be arbitrarily determined.

The information providing program 310 provides a function of recommending an app. The information providing program 310 includes a log acquiring unit 311, an analysis unit 312, a characterization unit 313, and a recommendation-information creating unit 314. The log acquiring unit 311 provides a function of acquiring log information from the mobile phone 100 and storing it in the log information 304. The analysis unit 312 provides a function of creating the analysis information 307 based on the log information 304. The characterization unit 313 provides a function of creating the characteristic information 308 based on the log information 304. The recommendation-information creating unit 314 provides a function of creating the recommendation information 309 based on the analysis information 307, the characteristic information 308 and the like.

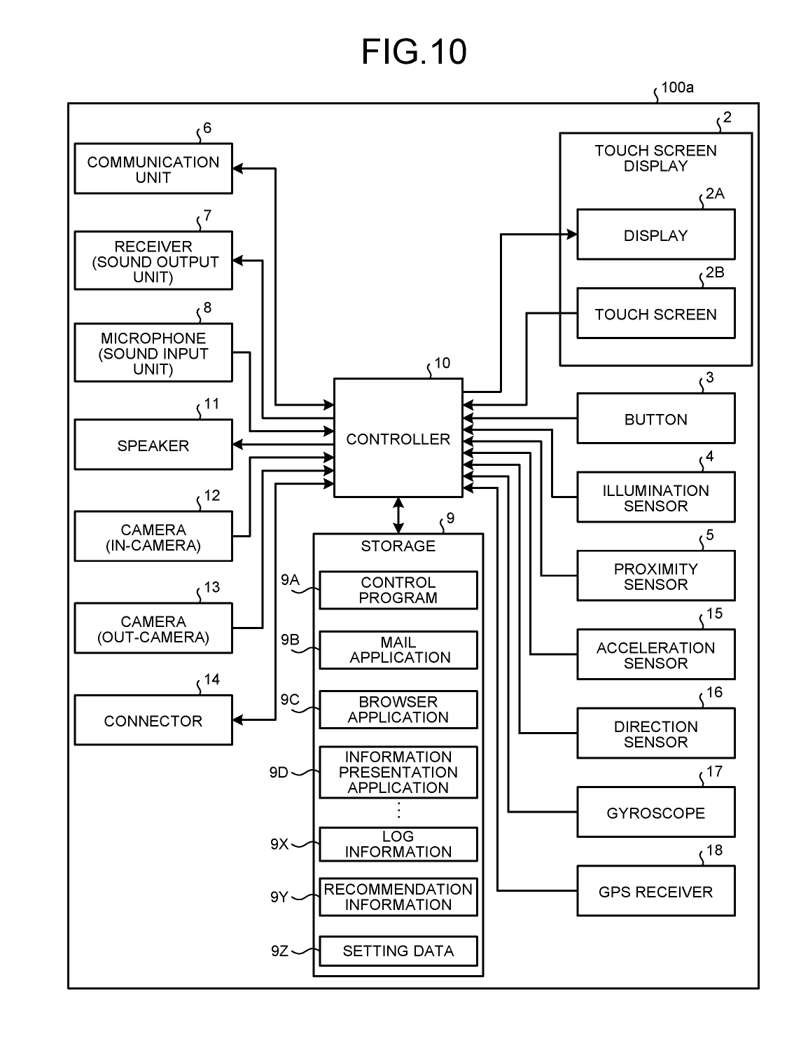

A configuration of the mobile phones 100a to 100z will be explained below with reference to FIG. 10 to FIG. 12. Because the mobile phones 100a to 100z have the same configuration as one another, the mobile phone 100a is used as an example to explain the configuration. As illustrated in FIG. 10, the mobile phone 100 includes a touch screen display 2, a button 3, an illumination sensor 4, a proximity sensor 5, a communication unit 6, a receiver 7, a microphone 8, a storage 9, a controller 10, a speaker 11, a camera 12, a camera 13, a connector 14, an acceleration sensor 15, a direction sensor 16, a gyroscope 17, and a Global Positioning System (GPS) receiver 18.

The touch screen display 2 includes a display 2A and a touch screen 2B. The display 2A is provided with a display device such as a liquid crystal display (LCD), an organic electro-luminescence display (OELD), or an inorganic electro-luminescence display (IELD). The display 2A displays text, images, symbols, graphics, and the like.

The touch screen 2B detects a contact of a finger, a pen, a stylus pen, or the like on the touch screen 2B. The touch screen 2B can detect positions where a plurality of fingers, pens, stylus pens, or the like make contact with the touch screen 2B. In the description herein below, a finger, a pen, a stylus pen, or the like which makes contact with the touch screen 2B may be called “contact object”.

The detection method of the touch screen 2B may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. In the description herein below, for the sake of simplicity, it is assumed that the user uses his/her finger(s) to make contact with the touch screen 2B in order to operate the mobile phone 100.

The mobile phone 100 determines a type of a gesture based on at least one of a contact detected by the touch screen 2B, a position where the contact is detected, a change of a position where the contact is detected, an interval between detected contacts, and the number of detection times of the contact. The gesture is an operation performed on the touch screen 2B. Examples of the gestures determined by the mobile phone 100 include, but are not limited to, a touch, a long touch, a release, a swipe, a tap, a double tap, a long tap, a drag, a flick, a pinch in, and a pinch out.

The button 3 is operated by the user. The controller 10 detects an operation for the button 3 in cooperation with the button 3. Examples of the operations for the button 3 include, but are not limited to, a click, a double click, a triple click, a push, and a multi-push.

The illumination sensor 4 detects illumination of the ambient light of the mobile phone 100. The illumination indicates intensity of light, lightness, or brightness. The illumination sensor 4 is used, for example, to adjust the brightness of the display 2A. The proximity sensor 5 detects the presence of a nearby object without any physical contact. The proximity sensor 5 detects the presence of the object based on a change of the magnetic field or a change of the return time of the reflected ultrasonic wave, etc. The proximity sensor 5 detects that, for example, the touch screen display 2 is brought close to someone's face. The illumination sensor 4 and the proximity sensor 5 may be configured as one sensor. The illumination sensor 4 can be used as a proximity sensor.

The communication unit 6 performs communication via radio waves. A communication system supported by the communication unit 6 is wireless communication standard. The wireless communication standard includes, for example, a communication standard of cellar phones such as 2G, 3G, and 4G. The communication standard of cellar phones includes, for example, Long Term Evolution (LTE), Wideband Code Division Multiple Access (W-CDMA), CDMA 2000, a Personal Digital Cellular (PDC), a Global System for Mobile Communications (GSM), and a Personal Handy-phone System (PHS). The wireless communication standard further includes, for example, Worldwide Interoperability for Microwave Access (WiMAX), IEEE 802.11, Bluetooth, Infrared Data Association (IrDA), and Near Field Communication (NFC). The communication unit 6 may support one or more communication standards.

The receiver 7 and the speaker 11 are sound output units. The receiver 7 and the speaker 11 output a sound signal transmitted from the controller 10 as sound. The receiver 7 is used, for example, to output voice of the other party on the phone. The speaker 11 is used, for example, to output a ring tone and music. Either one of the receiver 7 and the speaker 11 may double as the other function. The microphone 8 is a sound input unit. The microphone 8 converts speech of the user or the like to a sound signal and transmit the converted signal to the controller 10.

The storage 9 stores therein programs and data. The storage 9 is used also as a work area that temporarily stores a processing result of the controller 10. The storage 9 may include any non-transitory storage medium such as a semiconductor storage medium and a magnetic storage medium. The storage 9 may include a plurality type of storage mediums. The storage 9 may include a combination of a portable storage medium such as a memory card, an optical disc, or a magneto-optical disc with a reader of the storage medium. The storage 9 may include a storage device used as a temporary storage area such as Random Access Memory (RAM).

Programs stored in the storage 9 include applications executed in the foreground or the background and a control program for assisting operations of the applications. The application causes the controller 10, for example, to display a screen on the display 2A and perform a process according to a gesture detected through the touch screen 2B. The control program is, for example, an OS. The applications and the control program may be installed in the storage 9 through the communication by the communication unit 6 or through a non-transitory storage medium.

The storage 9 stores therein, for example, a control program 9A, a mail application 9B, a browser application 9C, an information presentation application 9D, log information 9X, recommendation information 9Y, and setting data 9Z. The control program 9A provides a function related to various controls for operating the mobile phone 100, for example, installation, execution, and deletion of various apps. When each of these events is executed, the control program 9A records information on the event in the log information 9X.

The mail application 9B provides an e-mail function for composing, transmitting, receiving, and displaying e-mail, and the like. The browser application 9C provides a WEB browsing function for displaying WEB pages.

The information presentation application 9D provides a function of presenting information related to an app whose installation is recommended to the user based on the presentation conditions. Specifically, the information presentation application 9D provides a function of transmitting the log information 9X, in which information related to events is accumulated, to the information providing apparatus 300. The information presentation application 9D provides a function of receiving the recommendation information 9Y from the information providing apparatus 300. Moreover, when a specified condition is satisfied, the information presentation application 9D provides a function of displaying information for recommending installation of a specified app on the display 2A based on the recommendation information 9Y.

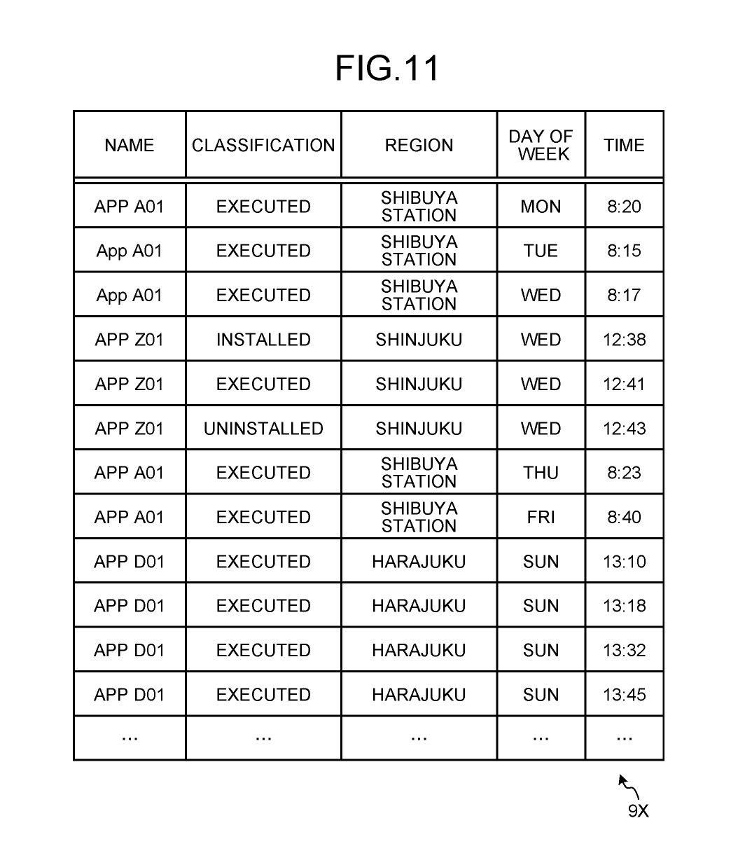

The log information 9X stores therein information related to events such as installation, execution, and deletion of apps in the mobile phones 100a. An example of the log information 9X is illustrated in FIG. 11. As illustrated in FIG. 11, the log information 9X includes items such as Name, Classification, Region, Day of Week, and Time.

Stored in the item of Name is a name of an app. The log information 9X may include an item for storing therein an identifier that identifies an app. Stored in the item of Classification is a value indicating a type of an event, such as “Installed” indicating that an app has been installed, “Uninstalled” indicating that an app has been uninstalled, and “Executed” indicating that an app has been executed. The item of Classification may store other values such as a value indicating that an app has been terminated, a value indicating that the setting of an app has been changed, and a value indicating that an app has been operated. The log information 9X may further include an item for storing therein a value indicating setting or details of an operation.

Stored in the item of Region is a value indicating a region where an event has occurred. The value indicating the region is specified based on the detection result of the GPS receiver 18 or based on a base station 200 with which the communication unit 6 establishes a communication path. The value indicating the region may be a name such as a place name or a code, or may be numerical values such as a latitude and a longitude. Stored in the item of Day of Week is a day of the week on which an event has occurred. The log information 9X may include an item for storing therein a date on which an event has occurred. Stored in the item of Time is a time at which an event has occurred.

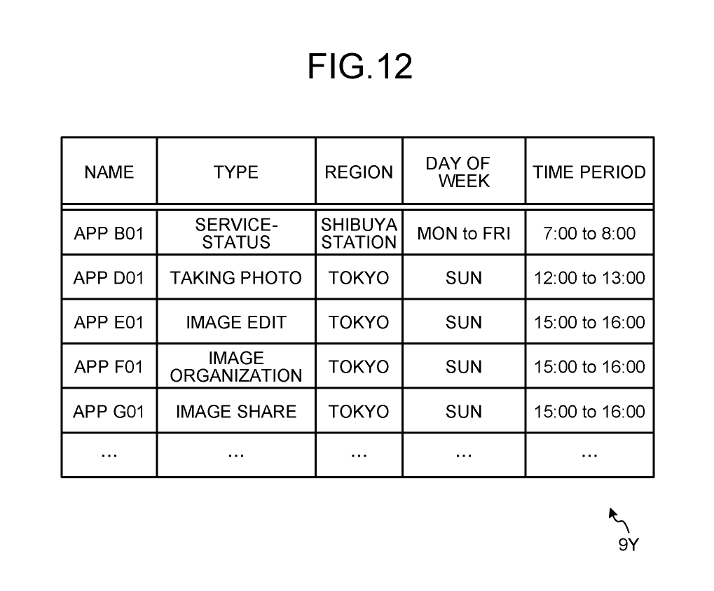

Stored in the recommendation information 9Y is information related to an app whose installation is recommended to the user and also related to presentation conditions for presenting the information on the recommendation to the user. An example of the recommendation information 9Y is illustrated in FIG. 12. As illustrated in FIG. 12, the recommendation information 9Y includes items such as Name, Type, Region, Day of Week, and Time Period. Stored in the item of Name is a name of an app whose installation is recommended to the user. Stored in the item of Type is a value indicating a type of an app whose installation is recommended to the user. Set in the item of Region is a value indicating a region where the recommendation to the user should be executed. Set in the item of Day of Week is a day of the week on which the recommendation to the user should be executed. Set in the item of Time Period is a time period during which the recommendation to the user should be executed.

The setting data 9Z contains information related to various settings on the operations of the mobile phone 100.

The controller 10 is a processing unit. Examples of the processing units include, but are not limited to, a Central Processing Unit (CPU), System-on-a-chip (SoC), a Micro Control Unit (MCU), and a Field-Programmable Gate Array (FPGA). The controller 10 integrally controls the operations of the mobile phone 100 to implement various functions.

Specifically, the controller 10 executes instructions contained in the program stored in the storage 9 while referring to the data stored in the storage 9 as necessary. The controller 10 controls a function unit according to the data and the instructions to thereby implement the various functions. Examples of the function units include, but are not limited to, the display 2A, the communication unit 6, the receiver 7, and the speaker 11. The controller 10 can change the control of the function unit according to the detection result of a detector. Examples of the detectors include, but are not limited to, the touch screen 2B, the button 3, the illumination sensor 4, the proximity sensor 5, the microphone 8, the camera 12, the camera 13, the acceleration sensor 15, the direction sensor 16, the gyroscope 17, and the GPS receiver 18.

The controller 10 executes, for example, the information presentation application 9D to thereby implement the function of presenting information related to the app whose installation is recommended to the user based on the presentation conditions.

The camera 12 is an in-camera for photographing an object facing the front face. The camera 13 is an out-camera for photographing an object facing the back face.

The connector 14 is a terminal to which other device is connected. The connector 14 may be a general-purpose terminal such as a Universal Serial Bus (USB), a High-Definition Multimedia Interface (HDMI), Light Peak (Thunderbolt), and an earphone/microphone connector. The connector 14 may be a dedicated terminal such as a dock connector. Examples of the devices connected to the connector 14 include, but are not limited to, an external storage device, a speaker, and a communication device.

The acceleration sensor 15 detects a direction and a magnitude of acceleration applied to the mobile phone 100. The direction sensor 16 detects a direction of geomagnetism. The gyroscope 17 detects an angle and an angular velocity of the mobile phone 100. The detection results of the acceleration sensor 15, the direction sensor 16, and the gyroscope 17 are used in combination with each other in order to detect a position of the mobile phone 100 and a change of its attitude. The GPS receiver 18 detects a position of the mobile phone 100.

Part or all of the programs and the data stored in the storage 9 in FIG. 10 may be downloaded from any other device through communication by the communication unit 6. Part or all of the programs and the data stored in the storage 9 in FIG. 10 may be stored in the non-transitory storage medium that can be read by the reader included in the storage 9. Part or all of the programs and the data stored in the storage 9 in FIG. 10 may be stored in the non-transitory storage medium that can be read by a reader connected to the connector 14. Examples of the non-transitory storage mediums include, but are not limited to, an optical disc such as CD, DVD, and Blu-ray, a magneto-optical disc, magnetic storage medium, a memory card, and solid-state storage medium.

The configuration of the mobile phone 100 illustrated in FIG. 10 is only an example, and therefore it can be modified as required within a scope that does not depart from the gist of the present invention. For example, in the example illustrated in FIG. 10, the mobile phone 100 is provided with two cameras; however, the mobile phone 100 may be provided with only one camera or with no camera. In the example of FIG. 10, the mobile phone 100 is provided with four types of sensors in order to detect its position and attitude; however, the mobile phone 100 does not have to be provided with some of the sensors. Alternatively, the mobile phone 100 may be provided with any other type of sensor for detecting at least one of the position and the attitude.

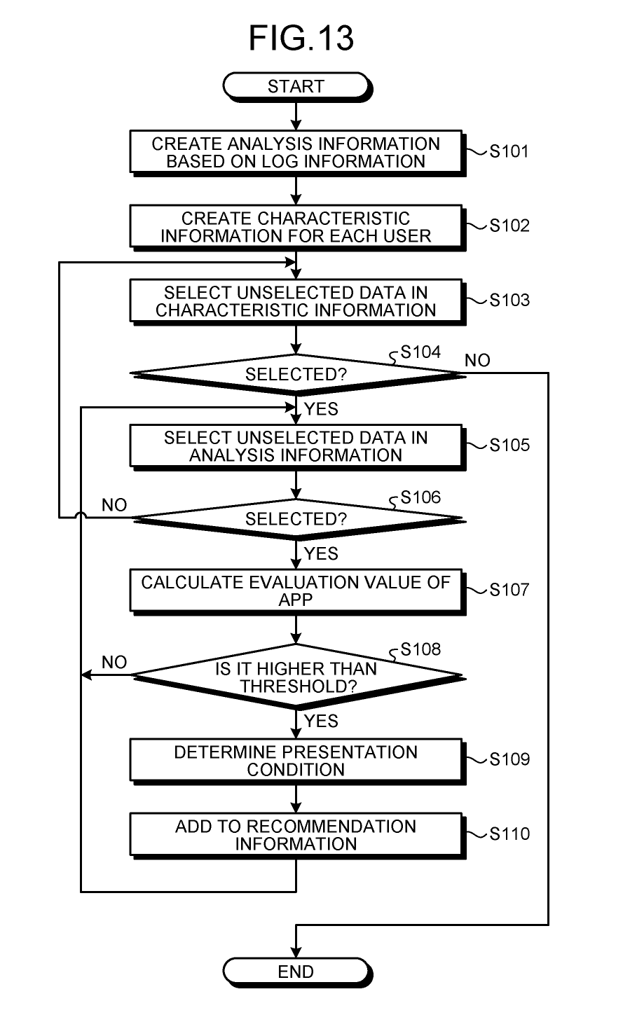

Details of the operations of the information providing system 1 will be explained below with reference to FIG. 13 to FIG. 16. FIG. 13 is a flowchart illustrating an operation of the information providing apparatus 300. The operation illustrated in FIG. 13 is implemented by the controller 302 of the information providing apparatus 300 executing the information providing program 310. The operation illustrated in FIG. 13 is periodically executed, for example, once a day.

The controller 302 creates the analysis information 307 being information on the usage pattern of the user based on the log information 304 (Step S101). The controller 302 then analyzes the characteristics of individual users based on the log information 304 and creates the characteristic information 308 (Step S102).

Subsequently, the controller 302 selects unselected data in the characteristic information 308 (Step S103). When the selection of unselected data has been done (Yes at Step S104), then the controller 302 selects unselected data in the analysis information 307 (Step S105). When the unselected data cannot be selected (No at Step S106), then the controller 302 re-executes Step S103 and subsequent steps.

When the unselected data is selected (Yes at Step S106), the controller 302 calculates an evaluation value used to determine whether the selected app is to be recommended to the user having the characteristic corresponding to the data selected at Step S103 (Step S107). When the evaluation value is higher than the threshold (Yes at Step S108), then the controller 302 determines a presentation condition (Step S109) and adds the data to the recommendation information 309 (Step S110). Thereafter, the controller 302 re-executes Step S105 and subsequent steps. When the evaluation value is not higher than the threshold (No at Step S108), then the controller 302 re-executes Step S105 and subsequent steps without adding any data to the recommendation information 309.

When unselected data in the characteristic information 308 cannot be selected at Step S103 (No at Step S104), the controller 302 ends the operation illustrated in FIG. 13.

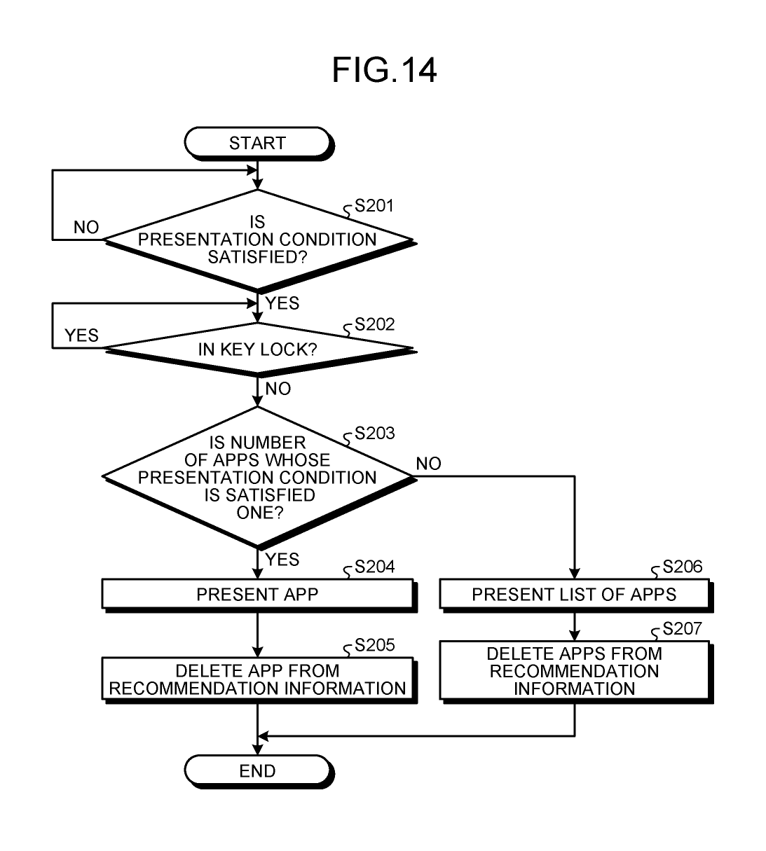

FIG. 14 is a flowchart illustrating an operation of the mobile phone 100. The operation illustrated in FIG. 14 is implemented by the controller 10 of the mobile phone 100 executing the information presentation application 9D. The operation illustrated in FIG. 14 is repeatedly executed while the mobile phone 100 works.

The controller 10 refers to the recommendation information 9Y to determine whether there is data whose presentation conditions are satisfied (Step S201). The presentation condition is determined as being satisfied when all the set conditions among the condition related to a region, the condition related to a day of the week, and the condition related to a time period are satisfied.

The condition related to a region is satisfied when the current position identified based on the detection result of the GPS receiver 18 or the base station 200, with which the communication unit 6 establishes the communication path, is included in the specified region. The condition related to a day of the week is satisfied when the current day of the week is a specified day of the week. The condition related to a time period is satisfied when the current time is included in a specified time period. If there is no data whose presentation condition is satisfied (No at Step S201), then the controller 10 re-executes Step S201.

When there is data whose presentation condition is satisfied (Yes at Step S201), the controller 10 determines whether the mobile phone 100 is in key lock (Step S202). Being in key lock represents a state in which the mobile phone 100 turns off the display 2A and stops the detection of the operation by the touch screen 2B. When it is in key lock (Yes at Step S202), the controller 10 re-executes Step S202.

When the mobile phone 100 is not in key lock (No at Step S202), the controller 10 determines whether a number of data (apps) which is related to an app included in the recommendation information 309 and whose presentation condition is satisfied is one (Step S203). When a number of data (apps) whose presentation condition is satisfied is one (Yes at Step S203), the controller 10 presents the app to the user (Step S204).

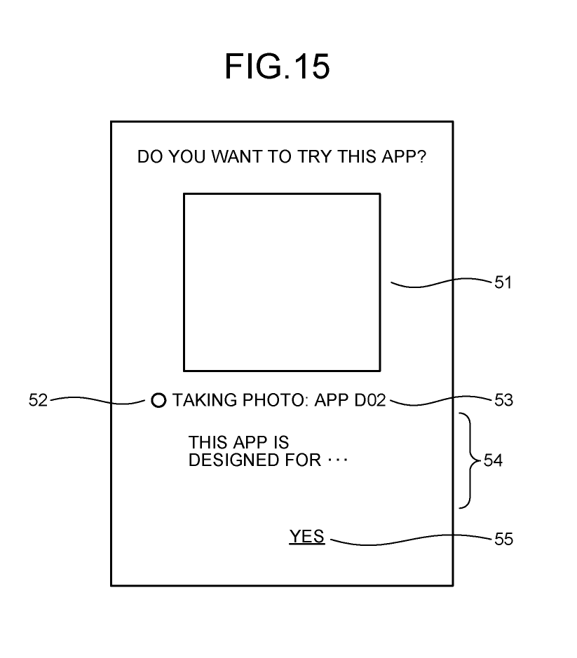

The presentation is performed by, for example, displaying a screen illustrated in FIG. 15 on the display 2A. The screen illustrated in FIG. 15 includes an icon 51 of an app, a type 52 of the app, a name 53 of the app, explanation 54 of the app, and a link 55 to WEB page for downloading of the app. The icon 51, the explanation 54, and the link 55 are obtained by, for example, querying a server from which the app is downloaded using the name of the app as a search key.

After the presentation, the controller 10 deletes the data corresponding to the presented app from the recommendation information 309 in order to avoid redundant presentation (Step S205).

When a number of data (app) whose presentation condition is satisfied is not one (No at Step S203), the controller 10 presents a list of the apps to the user (Step S206).

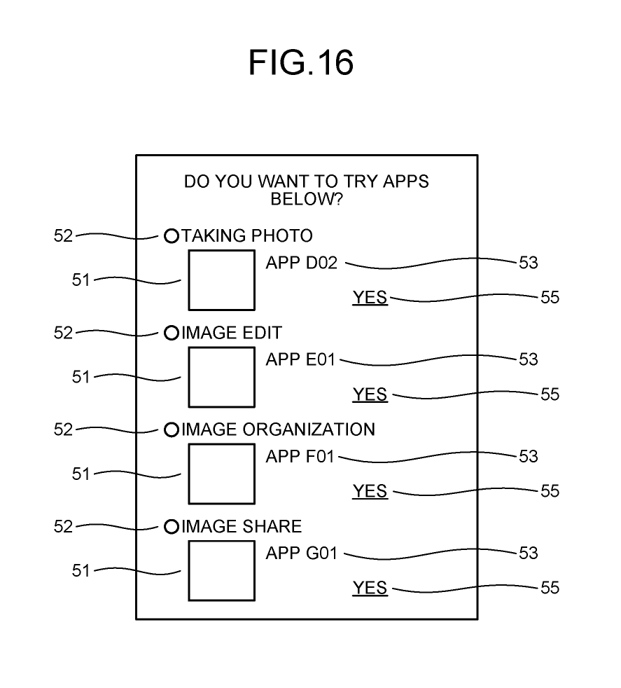

The presentation is performed by, for example, displaying a screen illustrated in FIG. 16 on the display 2A. The screen illustrated in FIG. 16 includes icons 51 of apps, types 52 of the apps, names 53 of the apps, and links 55 to WEB pages for downloading of the apps.

After the presentation, the controller 10 deletes the data corresponding to the presented apps from the recommendation information 309 in order to avoid redundant presentation (Step S207).

As explained above, the information providing system according to the present embodiment can present the information on the app suitable for the characteristics of the user at the timing according to the characteristics of the user to the user.

As one of examples, when the user often uses a transit guide app at a bus station on the way to work, then information related to a service-status app, which is highly associated with the transit guide app and is frequently used around the bus station in the time period when the user is going to work, can be presented to the user. The service-status app is an app that displays which bus is going where now. The information on the service-status app is presented to the user, for example, before he/she arrives at the bus station on the way to work. By presenting the information on the app at the effective timing in this way, the possibility that the user wants to install the app and try using it can be enhanced.

As another example, when the user uses a preinstalled camera app to often take photos Sunday afternoon, then information related to other popular camera app and information related to an image editing app, an image organizing app, an image sharing app, and so on, which handle taken photos, can be presented to the user. For example, the information on the camera app is presented before the time period when photos are taken on Sunday, and the information on the image editing app or so is presented after the time period when photos are taken on Sunday. By presenting the information on the apps at the effective timings in this way, the possibility that the user wants to install the apps and try using them can be enhanced.

The embodiment disclosed in the present application can be modified without departing the gist and the scope of the invention. Moreover, the embodiments and their modifications disclosed in the present application can be combined with each other if necessary. For example, the embodiment may be modified as follows.

For example, the programs illustrated in FIG. 3 and FIG. 10 may be divided into a plurality of modules, or may be combined with any other program.

The arrangement of the functions of the mobile phone 100 and the functions of the information providing apparatus 300 may be changed as necessary. For example, the information providing apparatus 300 executes only the functions of the log acquiring unit 311 and the analysis unit 312 in the information providing program 310, and may cause the mobile phone 100 to execute the functions of the characterization unit 313 and the recommendation-information creating unit 314 after transmission of the information required for each of the mobile phones 100.

In the embodiment, the mobile phone has been explained as an example of the mobile electronic device; however, the mobile electronic device according to the appended claims is not limited to the mobile phone. The mobile electronic device according to the appended claims may be a mobile electronic device other than the mobile phone. Examples of the mobile electronic devices include, but are not limited to, tablets, mobile personal computers, digital cameras, media players, electronic book readers, navigators, and gaming devices.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information providing apparatus, comprising:
a log acquiring unit configured to acquire log information indicating a usage pattern of a first application in a mobile electronic device from the mobile electronic device;
a characterization unit configured to analyze a usage characteristic of the first application in the mobile electronic device based on the log information acquired from the mobile electronic device, the usage characteristic including a characteristic related to a timing of usage; and
a recommendation-information creating unit configured to
determine a second application whose usage in the mobile electronic device is recommended based on an analysis result of the characterization unit and an evaluation value calculated using a result of analyzing usage patterns of a plurality of applications in a plurality of mobile electronic devices,
determine a timing of presenting information related to the second application in the mobile electronic device based on the analysis result of the characterization unit, and
create recommendation information including information related to the second application and information related to the determined timing,
wherein
the recommendation-information creating unit is configured to calculate the evaluation value as a weighted sum of
a degree of matching between (i) a region where the second application is used by the plurality of mobile electronic devices and (ii) a region corresponding to the usage characteristic of the first application by the mobile electronic device, and
a degree of matching between (i) a time period where the second application is used by the plurality of mobile electronic devices and (ii) a time period corresponding to the usage characteristic of the first application by the mobile electronic device.

2. The information providing apparatus according to claim 1, wherein
the recommendation-information creating unit is configured to determine the timing based on a temporal characteristic of the usage of the first application included in the analysis result of the characterization unit.

3. The information providing apparatus according to claim 1, wherein
the recommendation-information creating unit is configured to determine the timing based on a regional characteristic of the usage of the first application included in the analysis result of the characterization unit.

4. The information providing apparatus according to claim 1, wherein
the recommendation-information creating unit is configured to determine the timing of presenting information related to the second application information based on the analysis result related to the usage characteristic of the first application, and
the usage characteristic is a regional or a temporal characteristic related to the first application.

5. An information providing apparatus, comprising:
a log acquiring unit configured to acquire log information indicating a usage pattern of a first application in a mobile electronic device from the mobile electronic device;
a characterization unit configured to analyze a usage characteristic of the first application in the mobile electronic device based on the log information acquired from the mobile electronic device, the usage characteristic including a characteristic related to a timing of usage; and
a recommendation-information creating unit configured to
determine a second application whose usage in the mobile electronic device is recommended based on an analysis result of the characterization unit and an evaluation value calculated using a result of analyzing usage patterns of a plurality of applications in a plurality of mobile electronic devices,
determine a timing of presenting information related to the second application in the mobile electronic device based on the analysis result of the characterization unit, and
create recommendation information including information related to the second application and information related to the determined timing,
wherein
the recommendation-information creating unit is configured to calculate the evaluation value as a weighted sum of
a degree of matching between (i) a region where the second application is used by the plurality of mobile electronic devices and (ii) a region corresponding to the usage characteristic of the first application by the mobile electronic device, and
a degree of matching between (i) a time period where the second application is used by the plurality of mobile electronic devices and (ii) a time period corresponding to the usage characteristic of the first application by the mobile electronic device, and
the information providing apparatus further includes a storage unit containing
application types of the plurality of applications, and
predetermined different presentation times each corresponding to a pair of the application types.

6. The information providing apparatus according to claim 5, wherein
the recommendation-information creating unit is configured to determine the timing of presenting information related to the second application in the mobile electronic device based on
a first application type of the first application,
a second application type of the determined second application, and
the predetermined presentation time corresponding to the pair of the first application type and the second application type.

7. An information providing apparatus, comprising:
a log acquiring unit configured to acquire log information indicating a usage pattern of a first application in a mobile electronic device from the mobile electronic device;
a characterization unit configured to analyze a usage characteristic of the first application in the mobile electronic device based on the log information acquired from the mobile electronic device, the usage characteristic including a characteristic related to a timing of usage; and
a recommendation-information creating unit configured to
determine a second application whose usage in the mobile electronic device is recommended based on an analysis result of the characterization unit and an evaluation value calculated using a result of analyzing usage patterns of a plurality of applications in a plurality of mobile electronic devices,
determine a timing of presenting information related to the second application in the mobile electronic device based on the analysis result of the characterization unit, and
create recommendation information including information related to the second application and information related to the determined timing,
wherein
the recommendation-information creating unit is configured to calculate the evaluation value as a weighted sum of
a degree of matching between (i) a region where the second application is used by the plurality of mobile electronic devices and (ii) a region corresponding to the usage characteristic of the first application by the mobile electronic device, and
a degree of matching between (i) a time period where the second application is used by the plurality of mobile electronic devices and (ii) a time period corresponding to the usage characteristic of the first application by the mobile electronic device.

8. A mobile electronic device, comprising:
a display unit;
a communication unit configured to receive
log information indicating a usage pattern of a first application in the mobile electronic device,
a usage characteristic of the first application in the mobile electronic device analyzed based on the log information, the usage characteristic including a characteristic related to a timing of usage,
a second application whose usage in the mobile electronic device is recommended based on the usage characteristic and an evaluation value calculated using a result of analyzing usage patterns of a plurality of applications in a plurality of mobile electronic devices,
a timing of presenting information related to the second application in the mobile electronic device determined based on the usage characteristic, and
recommendation information including information related to the second application and information related to the determined timing;
a storage unit configured to store therein the log information; and
a control unit configured to
display the information related to the second application included in the recommendation information on the display unit at the timing included in the recommendation information, and
after displaying the information related to the second application on the display unit, delete (i) the information related to the second application and (ii) the timing of presenting the information related to the second application from the recommendation information, and
wherein the evaluation value is calculated as a weighted sum of
a degree of matching between (i) a region where the second application is used by the plurality of mobile electronic devices and (ii) a region corresponding to the usage characteristic of the first application by the mobile electronic device, and
a degree of matching between (i) a time period where the second application is used by the plurality of mobile electronic devices and (ii) a time period corresponding to the usage characteristic of the first application by the mobile electronic device.

9. The mobile electronic device according to claim 8, wherein
the timing is determined based on a temporal characteristic of the usage of the first application included in the usage characteristic.

10. The mobile electronic device according to claim 8, wherein
the timing is determined based on a regional characteristic of the usage of the first application included in the usage characteristic.

11. The mobile electronic device according to claim 8, wherein the control unit is configured to display the information related to the second application in a period when the first application is used by a user based on a temporal characteristic of usage of the first application included in the usage characteristic.

12. The mobile electronic device according to claim 8, wherein the control unit is configured to display the information related to the second application before a period when the first application is used by a user based on a temporal characteristic of usage of the first application included in the usage characteristic.

13. The mobile electronic device according to claim 8, wherein the control unit is configured to display the information related to the second application after a period when the first application is used by a user based on a temporal characteristic of usage of the first application included in the usage characteristic.

14. The mobile electronic device according to claim 8, further comprising a GPS receiver, wherein
the control unit is configured to determine a current position of the mobile electronic device using the GPS receiver, and
the control unit is configured to display the information related to the second application when the current position of the mobile electronic device is included in an area where the first application is used by a user based on a regional characteristic of usage of the first application included in the usage characteristic.

15. The mobile electronic device according to claim 8, wherein
the timing of presenting information related to the second application information is determined based on an analysis result related to the usage characteristic of the first application, and
the usage characteristic is a regional or a temporal characteristic related to the first application.

16. The mobile electronic device according to claim 8, wherein
the communication unit is configured to establish a communication path with a base station,
the control unit is configured to determine a current position of the mobile electronic device using the communication unit, and
the control unit is configured to display the information related to the second application when the current position of the mobile electronic device is included in an area where the first application is used by a user based on a regional characteristic of usage of the first application included in the analysis result of the characterization unit.

17. A mobile electronic device, comprising:
a display unit;
a communication unit configured to receive
log information indicating a usage pattern of a first application in the mobile electronic device,
a usage characteristic of the first application in the mobile electronic device analyzed based on the log information, the usage characteristic including a characteristic related to a timing of usage,
a second application whose usage in the mobile electronic device is recommended based on the usage characteristic,
an evaluation value calculated using a result of analyzing usage patterns of a plurality of applications in a plurality of mobile electronic devices,
a timing of presenting information related to the second application in the mobile electronic device determined based on the usage characteristic,
recommendation information including information related to the second application and information related to the determined timing,
application types of the plurality of applications, and
predetermined different presentation times each corresponding to a pair of the application types;
a storage unit configured to store therein the log information; and
a control unit configured to display the information related to the second application included in the recommendation information on the display unit at the timing included in the recommendation information,
wherein the evaluation value is calculated as a weighted sum of
a degree of matching between (i) a region where the second application is used by the plurality of mobile electronic devices and (ii) a region corresponding to the usage characteristic of the first application by the mobile electronic device, and
a degree of matching between (i) a time period where the second application is used by the plurality of mobile electronic devices and (ii) a time period corresponding to the usage characteristic of the first application by the mobile electronic device.

18. The mobile electronic device according to claim 17, wherein
the timing of presenting information related to the second application in the mobile electronic device is determined based on
a first application type of the first application,
a second application type of the determined second application, and
the predetermined presentation time corresponding to the pair of the first application type and the second application type.

19. A mobile electronic device, comprising:
a display unit;
a communication unit configured to receive
log information indicating a usage pattern of a first application in the mobile electronic device,
a usage characteristic of the first application in the mobile electronic device analyzed based on the log information, the usage characteristic including a characteristic related to a timing of usage,
a second application whose usage in the mobile electronic device is recommended based on the usage characteristic and an evaluation value calculated using a result of analyzing usage patterns of a plurality of applications in a plurality of mobile electronic devices,
a timing of presenting information related to the second application in the mobile electronic device determined based on the usage characteristic, and
recommendation information including information related to the second application and information related to the determined timing;
a storage unit configured to store therein the log information; and
a control unit configured to
display the information related to the second application included in the recommendation information on the display unit at the timing included in the recommendation information, and
stop displaying the information related to the second application after displaying the information once, even at the timing of presenting information related to the second application,
wherein the evaluation value is calculated as a weighted sum of
a degree of matching between (i) a region where the second application is used by the plurality of mobile electronic devices and (ii) a region corresponding to the usage characteristic of the first application by the mobile electronic device, and
a degree of matching between (i) a time period where the second application is used by the plurality of mobile electronic devices and (ii) a time period corresponding to the usage characteristic of the first application by the mobile electronic device.
